(19) United States
(12) Patent Application Publication
(10) Pub. No.: US 2008/0120355 A1
(43) Pub. Date: May 22, 2008

(54) SYSTEM AND METHOD FOR GENERATING MATHEMATICAL EQUATIONS AND SYMBOLIC SCIENTIFIC EXPRESSIONS IN HTML AND CSS

(75) Inventor: KEHINDE ALABI, ROCKY POINT, NY (US)

Correspondence Address: KEHINDE ALABI, 110 FRIENDSHIP DRIVE, ROCKY POINT, NY, 11778, US

(73) Assignee: KEHINDE ALABI, ROCKY POINT, NY (US)

(21) Appl. No.: 11/561,395

(22) Filed: Nov. 19, 2006

(51) Int. Cl. G06F 1/02; G06F 17/00; G06F 3/01

(52) U.S. Cl. 708/270; 715/234; 715/760

(57) ABSTRACT

A comprehensive method for generating mathematical equations and symbolic scientific expressions using pure HTML and CSS is disclosed. This method renders the equations portable and editable and contrasts with previous procedures that represent equations using a whole built-up graphic objects. An application of the method using HTML and JavaScript is also disclosed. Finally, a procedure for documenting the equations within the HTML document is included such that the equations are interpretable and can be converted to and from other formats such as LaTex, MATHML, or linear representation.

### REFERENCES CITED

U.S. Patent Documents

| | | | |
|---|---|---|---|
| 6,922,200 | July 2005 | Marques | 345/619 |
| 6,795,838 | September 2004 | Kataoka | 708/160 |
| 5,189,633 | February 1993 | Eisendrath et. al. | 708/142 |
| 20060059214 | March 2006 | Murray et. al. | 708/160 |
| 11,306,355 | December 2005 | Alabi | 434/322 |
| 11,534,679 | September 2006 | Alabi | 434/322 |

### OTHER PUBLICATIONS

Ken Alabi, NetBoxPro User Manuals, http://www.tutorcentral.net/NetBox/Help/netboxprohelp.html, November 2006.

Donald E. Knuth, The TeXbook, Reading Massachusetts, Addison Wesley 1984

Leslie Lamport, LaTeX: A Document Preparation System, User's Guide & Reference Manual, 2nd Ed., Addison Wesley, 1994.

Murray Sargent III, Unicode Nearly Plain-Text Encoding of Mathematics, Unicode Technical Note April 2006.

Hutchinson, T_{T}H: a “TeX to HTML” Translator, Vr. 3.43. http://hutchinson.belmont.ma.us/tth/manual/ April 2001.

Davies, J., et. al., “Knowledge Discovery and Delivery”, British Telecommunications Engineering, London, GB, vol. 17, No. 1, Apr. 1, 1998, pp. 25-35, XP-000765546.

Goker, A., “Capturing Information Need by Learning User Context”, 16^{th} International Joint Conference in Artificial Intelligence: Learning About User Workshop, Jul. 31, 1999, pp. 21-27, XP-002205013.

### CROSS REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, TABLE, OR A COMPUTER PROGRAM LISTING COMPACT DISK, APPENDIX

Not Applicable

### BACKGROUND OF THE INVENTION

The current invention pertains to the generation of mathematical equations and symbolic scientific expressions. In particular, the invention is aimed at solving the well known problem of generating mathematical equations and scientific notation on the World Wide Web.

Previous practice of the art of presenting equations within web pages has been guided by the belief that HTML, which is the dominant mode of presentation over the Internet, is not able to perform this function in its native form. Consequently, presentation of mathematical equations within web pages has been accomplished mainly in the following two ways.

In the first method, equations are created with an application or tool and converted into graphic files which are embedded within HTML pages. This method suffers from the fact that graphic files are usually larger than text files or pure HTML files resulting in slower presentation of the pages. Secondly, once converted into graphic form, the equations are not easily editable or modifiable on the presentation computer. In fact in most cases, one has to have access to or ownership of a copy of the generation application to edit the equation.

In the second method, Java applets are downloaded to the client or viewing computer and generate the equations on the same. This method also suffers from the additional applet download time and requires every client computer accessing the presentation page to download the applet. The extra requirement is a significant inconvenience as the number of computers with this applet would need to be considerable for the entire scheme to retain one of the biggest advantages of presenting material over the Internet—the lack of any burden on the user to install additional software in general.

The MATHML standard was devised by the W3C—the body that governs standards related to Internet documents and applications—to address this problem. The first specification was released in July 1999 and prescribes solutions both to the problem of presentation as well as that of documentation of mathematical notation. Several years since this release the problem remains unresolved for the several reasons:

The MATHML specification describes equations through a comprehensive set of XML tags. As a result, the format is almost impossible to author directly and additional tools and programs to edit the format are required.

MATHML is quite verbose and bulky. This can be attributed to the attempt by the standard to not only address the problem of presentation but that of documentation as well. The consequence of this would reflect on the download time of HTML pages that include MATHML equations.

The MATHML specification like Java applet presentation of mathematical equations require the client to either download applications that can present the format or have the format natively supported in all browsers. At this point, a majority of browsers still do not support this format and the process of adoption is a long way off.

There have been other efforts to display mathematical equations and symbolic scientific expression in pure HTML format. Most notable is the TTH LaTex to HTML application which translates LaTex equations into equations using only HTML syntax and fonts. However, the resulting equations aesthetically do not compare well with graphic equivalents generated in LaTex or other more traditional equation presentation medium.

Advances in HTML and web development technology led us to believe that the assumption of the inability of pure HTML to present equations acceptably needs to be revisited. In particular, the so-called AJAX technology combining HTML, CSS, Javascript and XML provide new opportunities to handle the generation and presentation of dynamic and more complicated content than was previously possible. For instance, support for UNICODE fonts and symbols have recently been utilized in enhancing the presentation of mathematical equations in linear form. An example is the work of Sargent et. al. (2004).

Marques (2005) showed that HTML alone can be used in presenting small graphics and charts without generating memory-intensive or bulky graphics as was the practice in prior art. The additional challenge with extending this or the linear format procedure to equations is that true presentation of equations requires a “built-up” form which requires additional processing. Innovative approaches and modification have to be developed taking advantage of some of the recent advances in HTML and AJAX technology. This is the approach in the current invention.

### BRIEF SUMMARY OF THE INVENTION

Disclosed is a comprehensive description of procedures for generating mathematical equations and symbolic scientific expression using CSS and pure HTML elements to present the same in built-up form. The format in which the equations are represented includes methods to additionally document the equations within the HTML resource in a manner that makes the equations editable or interpretable so that they are exportable to other formats such as LaTex, MATHML or UNICODE linear format.

For the presentation of equations, the method uses a comprehensive sequence of tables, table rows, and table cells with intuitive merging and splitting of cells to present built-up equations in HTML form. Each table which is part of an equation is referred to as an equation table, each row an equation row, and each cell an equation cell.

Symbols and parts of the representation may include small graphic symbols or UNICODE characters that are part of the HTML font library. Note that when small graphic symbols are used, this is distinct from the wholesale representation of the equation as graphics or bitmap as is currently practiced. Individual graphic symbols are handled in the same manner as font elements (some of which are really native small graphics) and can be manipulated as a unit, making editable an equation including such symbols.

Aspects of cascading styles (CSS) or simply styles associated with the HTML tags and modifying their appearance is used in influencing the rendering of the equations in graphic manner comparable to that obtained from LaTex and traditional equation processing tools in prior art. The style elements include those that influence the text spacing, text appearance as well as background characteristics of the equation tables and cells.

For generation, the current method discloses HTML and JavaScript client-side procedures to generate, modify, and manage the HTML equation elements and symbols. Symbols may be inserted via selection from a menu containing the symbols. Note that even though HTML client-side procedures are described for generating and modifying the equations, this is not to be construed as the limit of the generation and modification process in the current invention. In fact, one familiar with the art may easily recognize that the HTML equation presentation method described in this invention can be implemented in several ways including the preferred embodiment contained here.

Processes for editing and modifying equations follow naturally from the above since HTML equations are generated directly in a built-up form consisting of unit elements and symbols contained in distinct equation cells. Individual symbols and elements may be added or deleted and in fact the entire equation may be edited in place in a manner that is more flexible than traditional methods of generating equations including LaTex and MATHML.

For documentation, a set of names and identities are attached to each equation cell, row, or table during the generation process to describe its content. A comprehensive notation scheme is devised sufficient to allow any application (not only web browsers) to extract the HTML content of equations as text and interpret the equations and/or convert them into another format such as LaTex or MATHML.

### BRIEF DESCRIPTION OF THE DRAWINGS

FIG. 1 is a diagram that showing the environment for the generation of the equations in HTML in the preferred embodiment. The environment consists of an editing area and a system of menus and icons.

FIG. 2 is a diagram that shows icons for inserting a new equation and the initial table and cells generated in the editing area.

FIG. 3 is a diagram showing the table and cells for generating fractions in edit and presentation modes.

FIG. 4 is a diagram showing the tables and cells for generating matrices in edit and presentation modes.

FIG. 5 is a diagram showing the tables and cells for generating combined subscript ad superscript in edit and presentation modes.

FIG. 6 is a diagram showing the tables and cells for generating expression-fitting brackets in edit and presentation modes.

FIG. 7 is a diagram showing the tables and cells for generating expression-fitting horizontal accessories in edit and presentation modes.

FIG. 8 is a diagram showing the tables and cells for generating expression-fitting root symbols in edit and presentation modes.

FIG. 9 is a diagram showing the tables and cells for generating n-Ary expressions with the limits placed either in front or above the symbol in edit and presentation modes.

FIG. 10 is a diagram showing the tables and cells for generating conditional expressions and text within in edit and presentation modes.

FIG. 11 is a diagram showing the tables and cells for generating stacked expressions in edit and presentation modes.

FIG. 12 is a diagram showing the tables and cells for generating equation in edit and presentation modes.

FIG. 13 is a diagram showing the effect of using sub-cells in edit and presentation modes.

### DETAILED DESCRIPTION OF THE INVENTION

In the unit level, the elements of an HTML equation in the current disclosure consist of symbols and operators. Symbols may include fonts and small bits of graphics representing symbols and may include UNICODE symbols where supported by the browser. The symbols and operators have spacing and appearance that is distinct from ordinary text elements of an HTML presentation.

The presentation requirement is effected by applying and attaching an appropriate style to the equation cell, row, or table. The style may be implemented as a separate cascading style sheet (CSS) or contained directly within the HTML resource containing the equation. In addition, the style may be applied as a named style applied globally by tags or applied specifically within each HTML tag. In particular, setting text spacing and font style will cause the presentation of symbol and mathematical text to have an appearance desired for scientific symbol and mathematical expression. The font format can also be set directly or portions of an equation cell which are desired to be text or have a text-like appearance can be individually selected and set to text format.

Built-up portions of an equation include elements such as fractions, subscripts, superscripts, matrices, roots, variable size limiters, and decorations such as overbar and underbars. These items are referred to as built-up because of the two-dimensional requirements for their presentation as opposed to linear text which proceeds linearly either from left to right or the reverse. For instance, fractions may be presented as a numerator placed directly over a denominator. The procedure for generating built-up equation elements are presented next.

In the current disclosure, an expression will subsequently refer to at least one symbol or a combination of symbols which may be considered an equation in its own right.

Generating an equation involves entering the parts of the mathematical equation or scientific expression in the cells of the equation table. The parts may include variables (a, b, t, . . . ), operators (+, <, . . . ), functions and other textual content (sin, Re, log, . . . ), fractions, matrices, subscripts, superscripts, etc. In addition, sub-expressions may be placed within square, anglular, or regular, brackets, or fitted with decorations such as an overbar, vector bar, or underline.

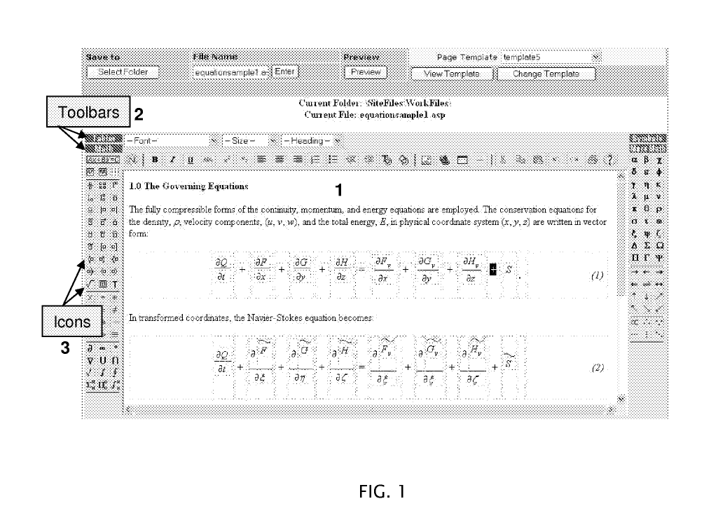

The Editing Environment consists of an editing area 1 and a system of toolbars 2 and icons 3 depicted in FIG. 1. The toolbars contain icons 3 for inserting or modifying parts of an equation or for inserting mathematical symbols. Some of the parts of an equation inserted or modified by icons are subsequently described.

Starting an Equation

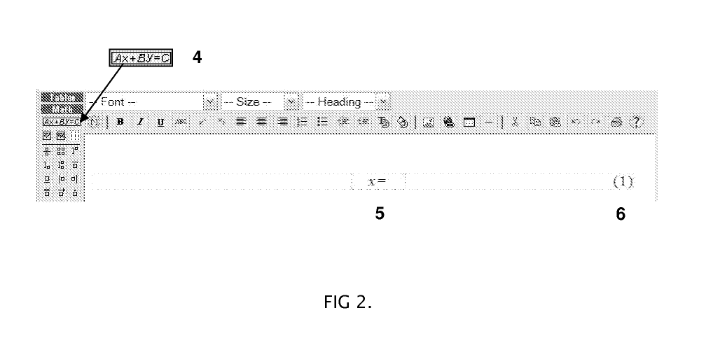

A new equation is started by clicking the New Equation icon 4 as shown in FIG. 2. In the current embodiment, the equation initially consists of three cells. The equation must be entered in the center or main cell 5 while the two cells at the edge are spacer cells. Equation labels may be entered in the right spacer cell 6. The cursor is automatically placed in the main equation cell.

Fractions

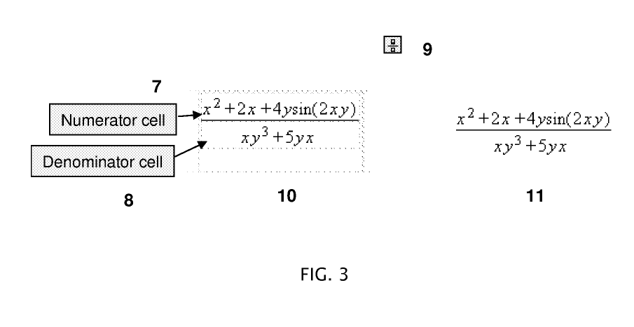

A fraction is entered as a numerator in a cell 7, and a denominator in a cell below it 8, with a dividing line as shown in FIG. 3. Clicking the fraction button 9 will create a numerator and denominator cell in a new cell next to the current one. If the current cell is empty, the cells are generated in the current cell. If a block of text is selected, the text is cut and placed in the numerator cell. The HTML fraction is illustrated in FIG. 3 in edit (left) 10 and presentation (right) modes 11.

Matrices

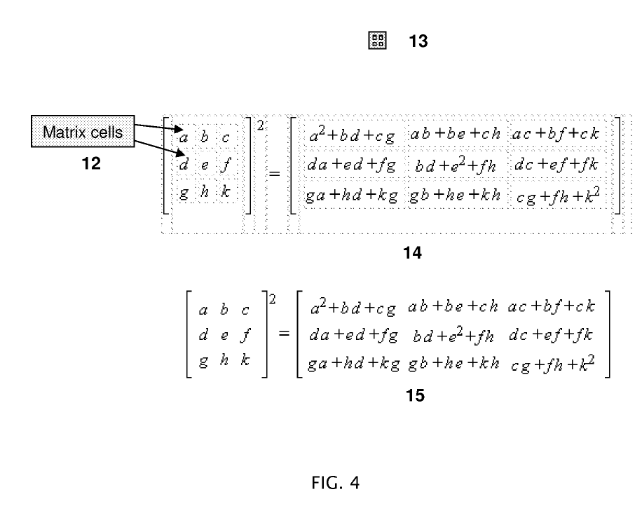

A matrix is entered as a table within an equation cell—the table containing as many cells 12 in rows and columns as the matrix. A matrix can be generated by clicking the matrix icon 13. The editor then queries the user for the number of rows and columns. The HTML math matrix is illustrated in FIG. 4 in edit 14 and presentation modes 15.

Subscripts and Superscripts

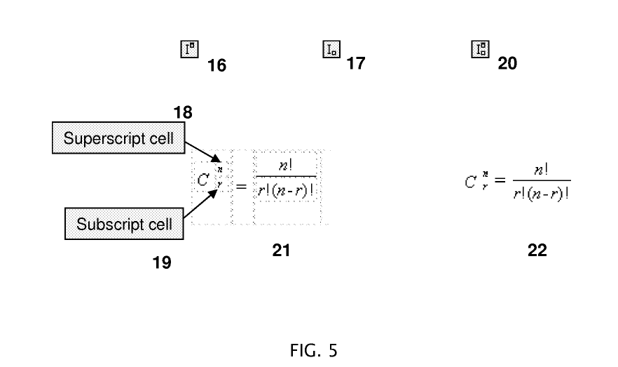

A superscript or subscript alone can be generated by clicking the superscript 16 and subscript 17 buttons. The selected text then becomes a superscript or subscript, respectively. If no text is selected, text entered at the cursor following the command is rendered as superscript or subscript. A combined superscript and subscript is represented as three cells. The cell at the left contains the operand (symbol to be raised to the power that also contains a subscript). The superscript is placed in the upper cell to the right 18 while the subscript is placed below it 19. A combined subscript and superscript is generated using the supsubscript icon 20. This is illustrated in FIG. 5 in edit 21 and presentation 22 modes. Note that the style applied to the subscript or superscript cell is such as to give an appropriate appearance by the use of a smaller font size than the default font size in an equation cell.

Fitting Expressions in Brackets

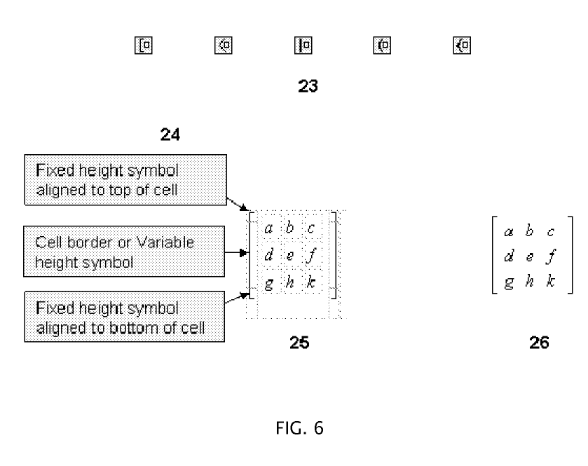

Expression-fitted brackets infer that the brackets stretch to fit the height of the expressions. Clicking on any of the bracket icons (left bracket icons shown in FIG. 6) 23 will insert a bracket to the left or right of the currently selected cell depending on whether the icon is a left or right bracket. The expression-fitting characteristic is generated by splitting the symbol into at least one variable height part and zero or more fixed height parts 24 as illustrated in FIG. 6. An expression fitted in brackets is depicted in edit 25 and presentation modes 26 in FIG. 6. Non-fitted brackets can also be entered directly in an expression, eg. (x+5).

Placing a Symbol or Accessory Over an Expression

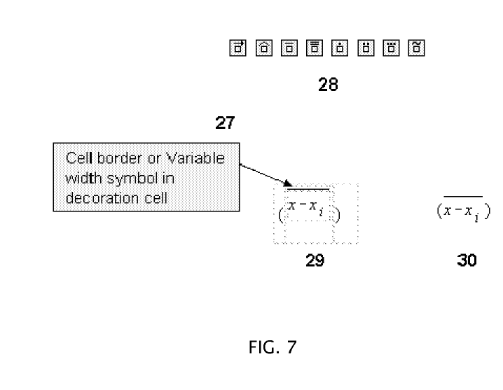

Bar, dot, accent, or a vector sign can be placed over a variable or sub-expression. The size of the accessory automatically sizes to fit the sub-expression. The expression-fitting characteristic is generated by splitting the symbol into at least one variable width part and zero or more fixed parts 27 as illustrated in FIG. 7. Clicking on any of the accessory icons 28 will insert the accessory in a cell above the current cell containing the variable or sub-expression. This is illustrated in FIG. 7 in edit 29 and presentation 30 modes.

Roots

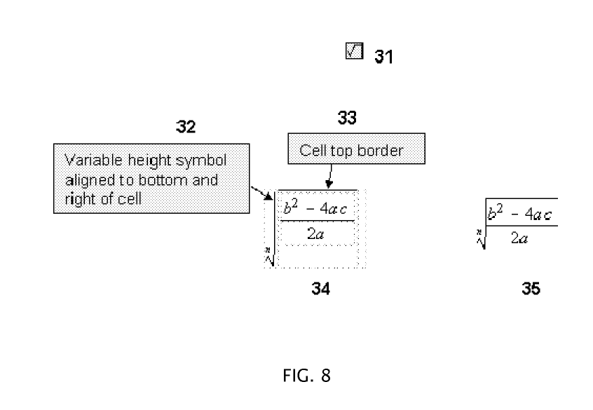

The root symbol can be used to enclose sub-expressions. The size of the symbol automatically adjusts to fit the sub-expression as shown in FIG. 8. Clicking on the root symbol 31 will insert a root cell into which the sub-expression may be entered. The root cell is bordered on the left and top by two cells with variable-size symbols 32. The root cell is illustrated in FIG. 8 in edit 33 and presentation 34 modes.

nAry Operators—Integral, Product, and Summation

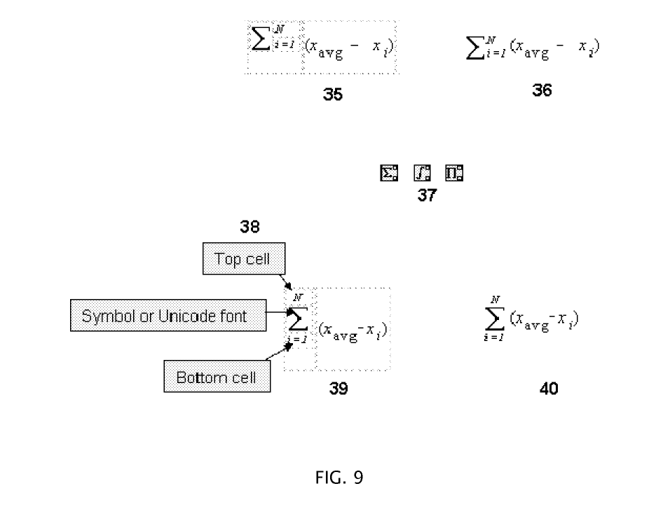

Mathematical integral, product and summation symbols may be entered with the limits either next to the operator or above the operator. To enter the mathematical symbols without any limits, the symbol from the appropriate icons in the toolbar may be clicked and the operand (summand, integrand, or product) placed next to it or in a new cell. To enter the symbols with the limits to the right, the combined superscript and subscript operator may be used. The operand is then entered in a cell to the right of the superscript and subscripts. This is illustrated in FIG. 9 in edit 35 and presentation modes 36. To enter the symbols with the limits above it, the appropriate icon 37 may be used. The limits can be entered in the cells above and below the symbol 38 shown in edit 39 and presentation modes 40 in FIG. 9.

Text and Functions in Expressions

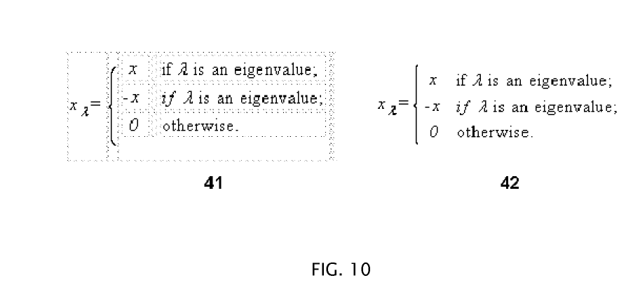

Variables or expressions can be converted into text by selecting them and clicking the text icon. The good thing is that equations are HTML and one can really add any text, image, or HTML element within an equation. An example of the use of text within an equation is illustrated in FIG. 10 in edit 41 and presentation 42 modes.

Conditions within Expressions

Conditions can be generated using an appropriate matrix and converting the condition expressions to text, as appropriate. An example of condition statements is illustrated in FIG. 10 in edit 41 and in presentation 42 modes.

Placing Stuff Above or Below Expressions

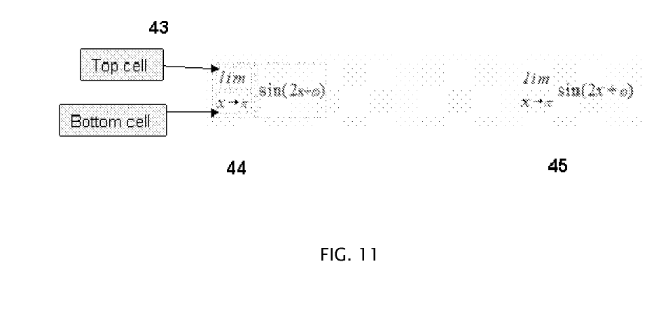

Expressions with sub-expressions stacked over each other like that illustrated in FIG. 11 can be generated using matrix cells. An example of a stacked sub-expression 43 is illustrated in FIG. 11 in edit 44 and in presentation 45 modes.

Equation Arrays

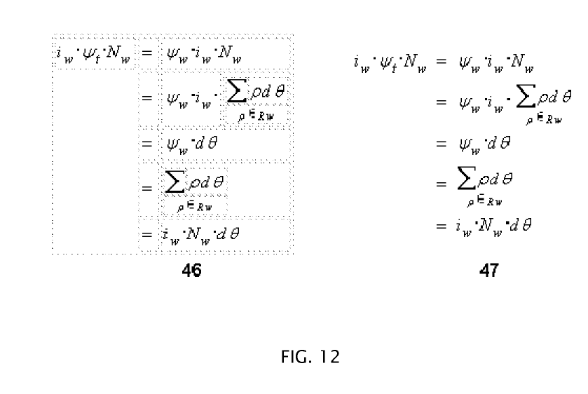

An equation array such as that shown below was generated using matrix cells. An equation array is illustrated in FIG. 12 in edit 46 and presentation 47 modes. This equation consists of several sub-expressions in sub-tables, and sub-cells generated using procedure described in this document.

More Precise Control of Equations and Expressions

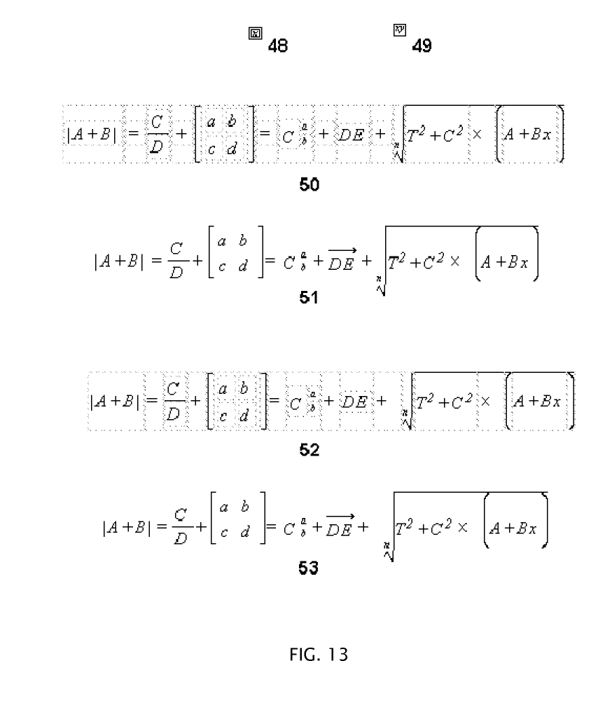

To influence the appearance of expressions further, sub-expressions may be placed within sub-cells to match other surrounding sub-expressions. A sub-cell icon is provided for creating a centered sub-cell within a cell. This icon is shown in FIG. 13 48 as is the new cell icon 49. An expression using sub-cells is shown in FIG. 13 50 51 compared to one not using sub-cells 52 53. The expressions do not look significantly different in presentation mode on most browsers but appears better in edit mode when using sub-cells.

Use of Spaces, Sub-Cells and Sub-Sub-Cells

Unlike other mathematical expression authoring tools (e.g. Tex), spaces can be inserted as is and the appearance of the expressions will be adjusted accordingly. Expressions may be created in cells and copied as a cell into another cell—creating as many depth and combination of cells and sub-cells as is needed to represent the equation. Table commands from the Table toolbar may also be used to combine or merge cells, split cells, as is desired. It should be noted in the above, that when sub-cells of a cell is created, the program generating the sub-cell additionally applies inheritance rules based on the style and type of the parent cell. For instance when a sub-cell of a superscript cell is created, this cell automatically assumes the font size of the parent cell. The general rule is to adopt the style of the parent cell. However, in instances, such as the generation of a subscript of a subscript, the child cell can be caused to have a still smaller size as a consequence of the parent cell.

Role of JavaScript

JavaScript commands are used to accomplish the actions described above, associated with clicking menu icons. In general, the JavaScript instructions invoked on clicking the icons may contain one or more of the following instructions:
commands to determine the position of the current cell within the context of the entire equation including to determine the parent cell and/or neighbor cells
commands to build or modify a section of HTML to present an equation according to the rules disclosed above for presenting HTML equations including those for inheritance for nested cells.
commands to generate the style and apply inheritance rules on any new table, cell, or sub-cell generated.
commands to position the cursor appropriately following the build-up or modification of the equation.

It should be noted, that in the current embodiment, we have utilized JavaScript and HTML alone to create an application to generate mathematical equations and symbolic scientific expressions. This is not to be construed as limiting the current invention as the application may be easily created in other programming language and/or environment. The elegance of the HTML generation tools disclosed in detail here is the fact that both the generation mechanism as well as the presentation of HTML equations are accomplished in the HTML environment (online in real-time, if required) using procedures available on most browsers without the need to purchase, download, or install additional software.

Due to the fact that the editor is implemented directly in HTML, the other parts of the documents as well as the equations may be directly edited. Spaces may be added as needed, symbols may be inserted from the keyboard or pasted from other documents or from the computer memory, new cells, may be added, split or merged as desired, and almost any HTML format may be applied within the equation.

Documenting HTML Equations

Documentation of HTML equations is an important part of the current invention. This was included so that the HTML contents of the current equation can be organized in form that allows their content to be interpreted and converted to other formats including Tex, LaTex, MATHML or Linear format.

Documentation is accomplished by taking advantage of the tagged nature of HTML itself. A further qualification of HTML is the fact that tags may be named or provided identification. As a result, the tags of the equation cells may be named such that the type of contents of the cells may be determined from the name of the cells. The following names, as an example, are a part of the current HTML disclosure:

| Element | Name |
|---|---|
| Fraction table | frac |
| Matrix table | matrix |
| Numerator cell | numerator |
| Denominator cell | denominator |
| Superscript cell | superscript |
| Subscript cell | subscript |
| Left square limiter cell | leftsqbrac |
| Right square limiter cell | rightsqbrac |
| Left curly limiter cell | leftcurlybrac |
| Right curly limiter cell | rightcurlybrac |
| Left angle limiter cell | leftanglebrac |
| Right angle limiter cell | rightanglebrac |
| Left bracket cell | leftbrac |
| Right bracket cell | rightbrac |
| Square root table | sqrt |
| Sum operator table | sum |
| Integral operator table | int |
| Product operator table | prod |
| Overbar cell | overbar |
| Dot on characters cell | overdot |
| Braces over characters cell | overbrace |
| Accent over characters cell | overaccent |
| Spacer cell | spacer |

One familiar with the current art may notice that some of the names are derived from commands in prior art such as in LaTex. This is simply to facilitate the easy development of converters to or from traditional equation forms.

Once the type of contents of a cell is determined, the exact contents of the cell may simply be determined directly from the HTML contents of the cell—since HTML equations are basically made up of texts and symbols. Further, the symbol images that are used to build the expressions are given names or filenames that have a descriptive order. For instance, the image used for the symbol “±” (if image symbols are used rather than Unicode or other font representation) is math_pm.gif (similar to \pm used in LaTex). Finally, named styles are also provided descriptive names. For instance, the text style is named math_text. Together, the entire content of HTML equations as disclosed here may be completely interpreted from the HTML text alone.

What is claimed is:

1. A method of interactively generating mathematical equations and symbolic scientific expressions in HTML using an application containing the following parts:
an editing area represented as a region in which the HTML equation is being generated or modified;
menus containing icons that can be activated to generate or modify a part or all of the equations in the edit area;
routines and programs that causes a response to the icon and menu events to generate or modify a part or all of the equations or expressions;

2. The method of claim 1 in which the equations or expressions are generated using the following elements—fonts, small graphics, small background graphics, or other hypertext markup language (HTML) parts.

3. The method of claim 1 in which the equations or expressions are generated in a system of one or more HTML table cells in HTML tables, where any of the cells may span one or more rows and/or columns, each cell containing none to several elements including fonts, small graphics, or small background graphics, or other HTML parts.

4. The method of claim 1 which may further include:
generating aspects of the equations within sub tables containing a system of HTML table cells containing some fonts, small graphics, or small background graphics appropriately aligned within the cell, where any or more of the cells may span one or more rows and/or columns—the combination being used to form a mosaic of a specific scientific or mathematical symbol;
generating the equations in a system of cells which may further contain nested equation HTML tables or cells containing sub-equation parts or sub-expressions;
using zero to more table cells with relative or specific sizes to fit the equation within the HTML tables;
formatting equation cells with none to several general or specific cascading sheet styles (CSS) causing the equations within the cells to be rendered in scientific or mathematical form;
setting up the nested equation cells such that they may inherit specific characteristics of or due to their parent cells.

5. A method of documenting the HTML parts of a mathematical equation or symbolic scientific expression, during the interactive generation of the same, composed of HTML tags, fonts, and small graphics pieces in a system of HTML table cells consisting of a set of documentation format and rules that are complete enough to enable the entire content of the equation or expression to be interpreted from its HTML representation. This documentation method additionally includes:
formats for describing the contents of cells through the cell name or identification;
formats for naming the styles applied to the HTML elements of the equation or expression.
formats for naming the small graphic pieces contained in the equation or expression.
formats for naming the image files that form a part or all of a symbol in the equation or expression.

6. A system and application for interactively generating mathematical equations and symbolic scientific expression in HTML using an application containing the following parts:
an editing area represented as a region in which the HTML equation is being generated or modified;
menus containing icons that can be activated to generate or modify a part or all of the equation in the edit area;
routines and programs that causes a response to the icon and menu events to generate or modify a part or all of the equation or expression;

7. The system of claim 6 in which the equations or expressions are generated using the following elements—fonts, small graphics, small background graphics, or other hypertext markup language (HTML) parts.

8. The system of claim 6 in which the equations or expressions are generated in a system of one or more HTML table cells in HTML tables, where any of the cells may span one or more rows and/or columns, each cell containing none to several elements including fonts, small graphics, or small background graphics, or other HTML part.

9. The system of claim 6 which may further include:
generating aspects of the equations within sub tables containing a system of HTML table cells containing some fonts, small graphics, or small background graphics appropriately aligned within the cell, where any or more of the cells may span one or more rows and/or columns—the combination being used to form a mosaic of a specific scientific or mathematical symbol;
generating the equations in a system of cells which may further contain nested equation HTML tables or cells containing sub-equation parts or sub-expressions;
using zero to more table cells with relative or specific sizes to fit the equation within the HTML tables;
formatting equation cells with none to several general or specific cascading sheet styles (CSS) causing the equations within the cells to be rendered in scientific or mathematical form;
setting up the nested equation cells such that they may inherit specific characteristics of or due to their parent cells.
